(19) United States
(12) Patent Application Publication
(10) Pub. No.: US 2018/0039133 A1
(43) Pub. Date: Feb. 8, 2018

(54) TOUCH CONTROL LIQUID CRYSTAL DISPLAY DEVICE AND ELECTRONIC APPARATUS

(71) Applicant: Wuhan China Star Optoelectronics Technology Co. Ltd., Wuhan, Hubei (CN)

(72) Inventors: Zhenzhou XING, Wuhan (CN); Bin XIONG, Wuhan (CN)

(21) Appl. No.: 14/913,910

(22) PCT Filed: Feb. 4, 2016
(86) PCT No.: PCT/CN2016/073543

§ 371 Date: Feb. 23, 2016

(30) Foreign Application Priority Data
Jan. 12, 2016 (CN) 201610016566.2

(51) Int. Cl. G02F 1/1335; G02F 1/1333

(52) U.S. Cl. CPC G02F 1/133528; G02F 1/13338; G02F 2201/50; G02F 2001/133562; G02F 2001/133567; G02F 2202/022; G02F 1/1368

(57) ABSTRACT

A touch control LCD including a backlight module and a liquid crystal panel disposed opposite each other, the liquid crystal panel includes glass first and second substrates and a liquid crystal layer disposed there between. A thin film transistor array disposed on one side of the first substrate toward the liquid crystal layer, a color filter disposed on one side of the second substrate toward the liquid crystal layer, a cover lens disposed on the second substrate, and a touch control electrode structure disposed in the liquid crystal panel. A side of the first substrate away from the liquid crystal layer is coupled with a first polarizing film through a coating film. The second substrate side away from the liquid crystal layer or a second substrate side toward the cover lens is coupled with a second polarizing film through the coating film. An electronic apparatus including the LCD is disclosed.

### TECHNICAL FIELD

The present invention relates to a liquid crystal display technical field, and particularly, to a touch control liquid crystal display device and an electronic apparatus including the touch control liquid crystal display device.

### BACKGROUND ART

With a rapid development of a display technology, a Touch Screen Panel has been gradually spread to people's lives. According to composition structures, the touch panel may be divided into: an Add on Mode panel, an On-Cell Touch Panel and an In-Cell Touch Panel. Wherein, the Add on Mode panel is formed by separately manufacturing a touch screen from a liquid crystal display screen, and then attaching them together to form a liquid crystal display screen having a touch function; the On-Cell Touch Panel is formed by inserting a touch screen between a color filter substrate of a liquid crystal display screen and a polarizer; and the In-Cell Touch Panel is formed by embedding a touch control electrode of a touch screen in a liquid crystal display screen (preparing the touch control electrode in an array substrate or a color filter substrate), thereby reducing a thickness of a whole module, and greatly lowering cost of preparing the touch screen, and such touch screen is preferred by all panel manufacturers.

Take the On-Cell Touch Panel as an example, a structure schematic view of an existing On-Cell Touch Display Panel is shown in FIG. 1, the touch display panel includes a backlight module 1 and a liquid crystal panel 2, the liquid crystal panel 2 includes an array substrate 3 and an filter substrate 4 disposed opposite to each other and a liquid crystal layer 5 disposed between the array substrate 3 and the filter substrate 4, a lower polarizer 6a is disposed under the array substrate 3, an upper polarizer 6b is disposed over the filter substrate 4, and a cover lens 7 is disposed on the upper polarizer 6b. Wherein, a touch control electrode structure 8 of the touch screen is disposed between the filter substrate 4 and the upper polarizer 6b.

Generally, polarization directions of the lower polarizer 6a and the upper polarizer 6b are disposed vertically to each other, the backlight module emits lights to form linear linearly polarized lights through the lower polarizer 6a, and the linearly polarized lights are deflected after passing through the liquid crystal layer 5, and then are emitted from the upper polarizer 6a. Wherein, as shown in FIG. 2, the existing polarizers (the lower polarizer 6a and the upper polarizer 6b) usually include a Release film 601, a Pressure Sensitive Adhesive (PSA) thin film 602, a first Triacetyl Cellulose (TAC) thin film 603, a Polyvinyl alcohol (PVA) thin film 604, a second TAC thin film 605 and a Protective film 606.

In recent years, the touch display screen is widely used in all kinds of electronic products, a developing trend that the electronic products having touch screens become lighter and thinner is more apparent. However, the polarizer having the above structure includes many structural layers, which is not beneficial to the lighter and thinner design of the touch display screen.

### SUMMARY

In view of this, the present invention provides a touch control liquid crystal display device, and the liquid crystal display device having a thinner thickness can be obtained by improving a structure part for implementing the polarizing function.

In order to achieve the above purpose, the present invention adopts the following technical solutions:

A touch control liquid crystal display device includes a backlight module and a liquid crystal panel disposed opposite to each other, the liquid crystal panel includes: a first glass substrate and a second glass substrate; a liquid crystal layer disposed between the first glass substrate and the second glass substrate; a thin film transistor array disposed on a side of the first glass substrate toward the liquid crystal layer; a color filter disposed on a side of the second glass substrate toward the liquid crystal layer; a cover lens is disposed on the second glass substrate; and a touch control electrode structure disposed in the liquid crystal panel, wherein a side of the first glass substrate away from the liquid crystal layer is coupled with a first polarizing film through a coating process, and a side of the second glass substrate away from the liquid crystal layer or a side of the second glass substrate toward the cover lens is coupled with a second polarizing film through the coating process.

Wherein, materials of the first polarizing film and the second polarizing film are polyvinyl alcohol.

Wherein, thicknesses of the first polarizing film and the second polarizing film are 5 μm to 10 μm, respectively,

Wherein, the thicknesses of the first polarizing film and the second polarizing film are 8 μm, respectively.

Wherein, the liquid crystal panel is an On-Cell Touch panel, wherein when the second polarizing film is coupled to the second glass substrate, the touch control electrode structure is disposed between the second polarizing film and the cover lens; and when the second polarizing film is coupled to the cover lens, the touch control electrode structure is disposed between the second polarizing film and the second glass substrate.

Wherein, the liquid crystal panel is an In-Cell Touch panel, wherein the touch control electrode structure is disposed on the first glass substrate and between the liquid crystal layer and the thin film transistor array.

Wherein, the liquid crystal panel is the In-Cell Touch panel, wherein, the touch control electrode structure is disposed on the second glass substrate and between the second glass substrate and the color filter.

The present invention also provides an electronic apparatus, which includes a housing and a liquid crystal display device sealed in the housing, wherein the liquid crystal display device is the above touch control liquid crystal display device.

The present invention provides a touch control liquid crystal display device and an electronic apparatus, by improving a structure part for implementing the polarizing function, coupling the polarizing film to the first glass substrate, the second glass substrate or the cover lens through a coating process, and using the glass substrates as protective layers of the polarizing film, both sides of the polarizing film no longer need other protective layer structures, such that the structure for implementing the polarizing function only includes one layer of polarizing film. In comparison with the polarizer having a multiple-layered film structure used in the prior art, a liquid crystal display device with a thinner thickness can be obtained.

### BRIEF DESCRIPTION OF THE DRAWINGS

FIG. 1 is a structure schematic view of an On-Cell Touch Panel in the prior art;

FIG. 2 is a structure schematic view of a polarizer in the prior art;

FIG. 3 is a structure schematic view of a touch control liquid crystal display device provided by Embodiment 1 of the present invention;

FIG. 4 is a structure schematic view of a touch control liquid crystal display device provided by Embodiment 2 of the present invention;

FIG. 5 is a structure schematic view of a touch control liquid crystal display device provided by Embodiment 3 of the present invention; and

FIG. 6 is a structure schematic view of an electronic apparatus provided by Embodiment 4 of the present invention.

### DETAILED DESCRIPTION OF EXEMPLARY EMBODIMENTS

In order for the purpose, technical solution and advantages of the present invention to be clearer, specific embodiments of the present invention will be explained below in detail in conjunction with the drawings. Examples of these preferred embodiments were illustrated in the drawings. The embodiments of the present invention shown in the drawings and described according to the drawings are only illustrated, and the present invention is not limited to these embodiments.

Here, it also needs to explain that, in order to avoid blurring the present invention due to unnecessary details, the drawings only illustrate structures and/or processing steps closely related to the solution of the present invention, but other details having less relationship with the present invention are omitted.

### Embodiment 1

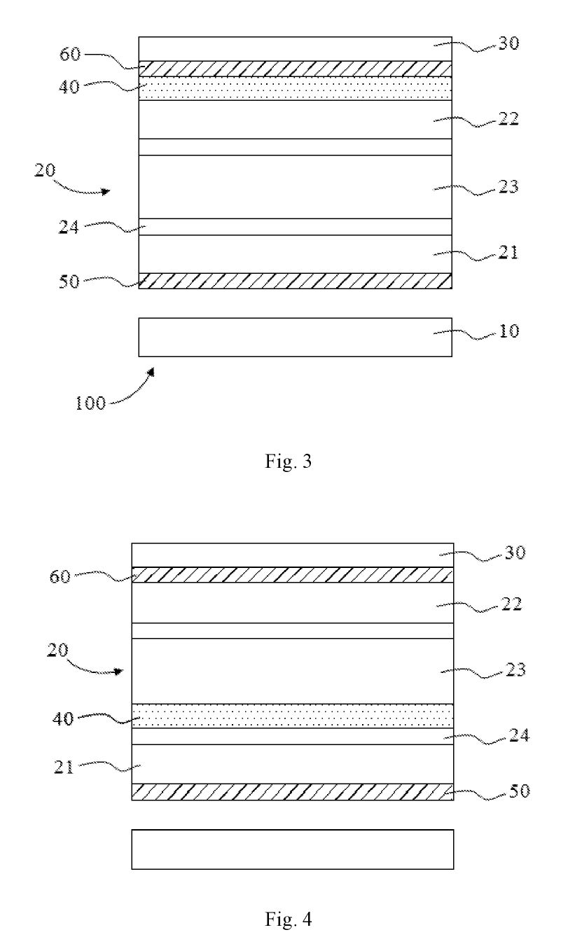

The present Embodiment 1 provides a touch control liquid crystal display device, as shown in FIG. 3, the liquid crystal display device 100 mainly includes a backlight module 10 and a liquid crystal panel 20 disposed opposite to each other, the backlight module 10 is used to provide backlights to the liquid crystal panel 20, such that the liquid crystal panel 20 displays an image.

Wherein, the liquid crystal panel 20 includes a first glass substrate 21, a second glass substrate 22 and a liquid crystal layer 23 disposed between the first glass substrate 21 and the second glass substrate 22, a side of the first glass substrate 21 toward the liquid crystal layer 23 is provided with a thin film transistor array 24, a side of the second glass substrate 22 toward the liquid crystal layer 23 is provided with a color filter 25, and a cover lens 30 is disposed on the second glass substrate 22. The liquid crystal panel 20 in the present embodiment is an On-Cell Touch panel, which includes a touch control electrode structure 40, and the touch control electrode structure 40 is disposed between the second glass substrate 22 and the cover lens 30.

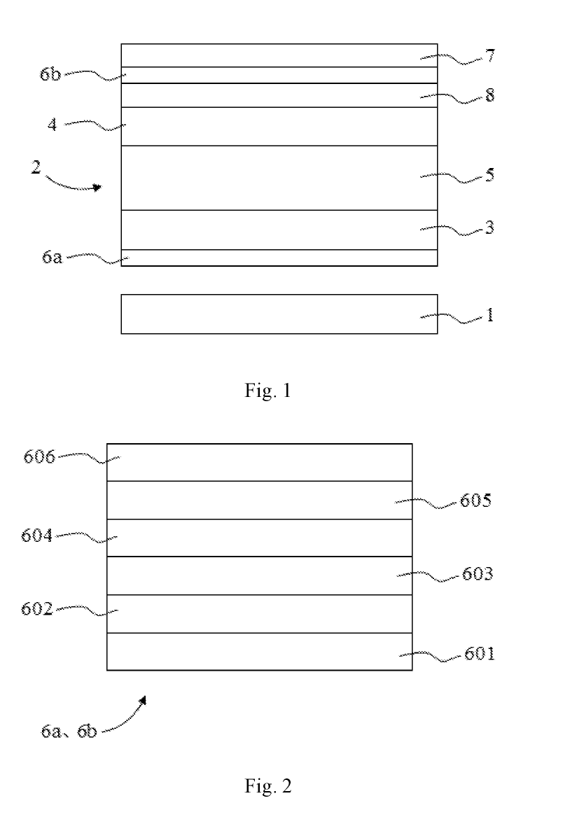

In this embodiment, as shown in FIG. 1, a side of the first glass substrate 21 away from the liquid crystal layer 23 is coupled with a first polarizing film 50 through a coating process; a side of the cover lens 30 toward the second glass substrate 22 is coupled with a second polarizing film 60 through the coating process. At this time, the touch control electrode structure 40 is disposed between the second polarizing film 60 and the second glass substrate 22. In other embodiments, the second polarizing film 60 may be coupled to a side of the second glass substrate 22 away from the liquid crystal layer 23 through the coating process. At this time, the touch control electrode structure 40 is positioned between the second polarizing film 60 and the cover lens 30.

Wherein, materials of the first polarizing film 50 and the second polarizing film 60 are polyvinyl alcohol (PVA), that is, the first polarizing film 50 and the second polarizing film 60 for implementing the polarizing function only include PVA material layers respectively, and does not include any other material layers. Thicknesses of the first polarizing film 50 and the second polarizing film 60 may be selected as 5 μm to 10 μm, respectively, and the most preferred numerical value is 8 μm.

### Embodiment 2

This embodiment differs from Embodiment 1 in that the liquid crystal panel in the present embodiment is an In-Cell Touch Panel. In specific, as shown in FIG. 4, the touch control electrode structure 40 in the liquid crystal panel 20 is disposed on the first glass substrate 21 and between the liquid crystal layer 23 and the thin film transistor array 24. Furthermore, in the present embodiment, the first polarizing film 50 is the same as that in Embodiment 1, and the second polarizing film 60 is coupled to a side of the second glass substrate 22 away from the liquid crystal layer 23 through the coating process. Of course, the second polarizing film 60 also may be coupled to the cover lens 30 through the coating process.

### Embodiment 3

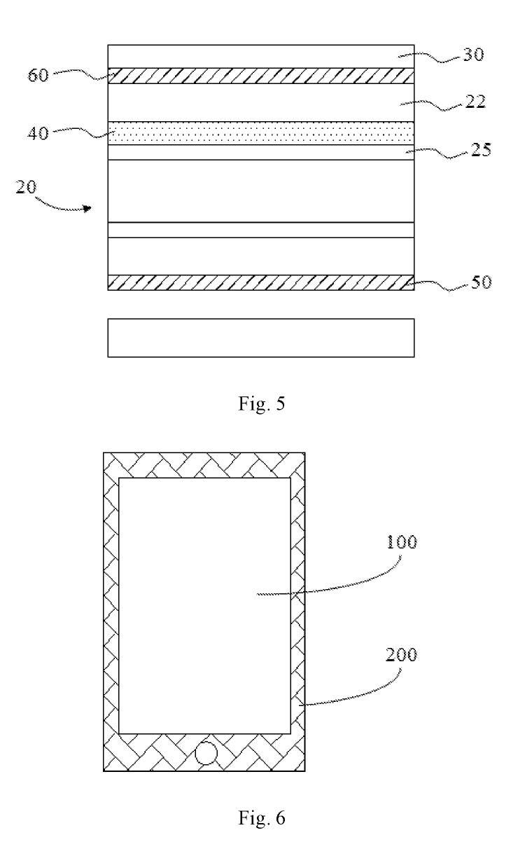

This embodiment differs from Embodiment 2 in that, as shown in FIG. 5, the touch control electrode structure 40 in the liquid crystal panel 20 is disposed on the second glass substrate 22 and between the second glass substrate 22 and the color filter 25. Furthermore, in the present embodiment, the first polarizing film 50 is the same as that in Embodiment 2, and the second polarizing film 60 is coupled to the cover lens 30 through the coating process. Of course, the second polarizing film 60 also may be coupled to the second glass substrate 22 through the coating process.

### Embodiment 4

This embodiment provides an electronic apparatus, as shown in FIG. 6, the electronic apparatus includes a housing 200 and a liquid crystal display device 100 sealed in the housing 200. Wherein, the liquid crystal display device 100 is the above touch control liquid crystal display device 100.

In summary, in the touch control liquid crystal display device and the electronic apparatus, by improving the structure part for implementing the polarizing function, coupling the polarizing film to the first glass substrate, the second glass substrate or the cover lens through a coating process, and using the glass substrates as protective layers of the polarizing film, both sides of the polarizing film no longer need other protective layer structures, such that the structure for implementing the polarizing function only includes one layer of polarizing film. In comparison with the polarizer having a multiple-layered film structure used in the prior art, a liquid crystal display device with a thinner thickness can be obtained.

It should be explained that the relationship terms, such as first and second, etc., in the present text are only used for distinguishing one entity or operation from another entity or operation without requiring or implying any actual relation or sequence existing between these entities or operations. Moreover, the term “include”, “contain” or any other variant is intended to cover instead of exclusively include, so that the process, method, object or device including a series of factors not only includes those factors but also includes other factors that are not explicitly listed or further include inherent factors for this process, method, object or device. Where no more limitations are provided, the factors defined by the sentence “include one . . . ” do not exclude additional identical factors existing in the process, method, object or device which includes the factors.

The above statements are only the specific embodiments of the present application, it should be pointed out that, to those ordinary skilled in the art, several improvements and modifications can be made without departing from the principle of the present application, also those improvements and modifications should be considered as the protection scope of the present application.

1. A touch control liquid crystal display device, comprising a backlight module and a liquid crystal panel disposed opposite to each other, wherein the liquid crystal panel comprises:
a first glass substrate and a second glass substrate;
a liquid crystal layer disposed between the first glass substrate and the second glass substrate;
a thin film transistor array disposed on a side of the first glass substrate toward the liquid crystal layer;
a color filter disposed on a side of the second glass substrate toward the liquid crystal layer;
a cover lens disposed on the second glass substrate; and
a touch control electrode structure disposed in the liquid crystal panel,
wherein a side of the first glass substrate away from the liquid crystal layer is coupled with a first polarizing film through a coating process, and a side of the second glass substrate away from the liquid crystal layer or a side of the cover lens toward the second glass substrate is coupled with a second polarizing film through the coating process.

2. The touch control liquid crystal display device of claim 1, wherein materials of the first polarizing film and the second polarizing film are polyvinyl alcohol (PVA).

3. The touch control liquid crystal display device of claim 2, wherein thicknesses of the first polarizing film and the second polarizing film are 5 μm to 10 μm, respectively.

4. The touch control liquid crystal display device of claim 2, wherein the thicknesses of the first polarizing film and the second polarizing film are 8 μm, respectively.

5. The touch control liquid crystal display device of claim 1, wherein the liquid crystal panel is an On-Cell Touch panel,
wherein when the second polarizing film is coupled to the second glass substrate, the touch control electrode structure is disposed between the second polarizing film and the cover lens; and when the second polarizing film is coupled to the cover lens, the touch control electrode structure is disposed between the second polarizing film and the second glass substrate.

6. The touch control liquid crystal display device of claim 1, wherein the liquid crystal panel is an In-Cell Touch panel, wherein the touch control electrode structure is disposed on the first glass substrate and between the liquid crystal layer and the thin film transistor array.

7. The touch control liquid crystal display device of claim 1, wherein the liquid crystal panel is an In-Cell Touch panel, wherein the touch control electrode structure is disposed on the second glass substrate and between the second glass substrate and the color filter.

8. An electronic apparatus comprising a housing and a liquid crystal display device sealed in the housing, the liquid crystal display device being a touch control liquid crystal display device that comprises a backlight module and a liquid crystal panel disposed opposite to each other, and the liquid crystal panel comprises:
a first glass substrate and a second glass substrate;
a liquid crystal layer disposed between the first glass substrate and the second glass substrate;
a thin film transistor array disposed on a side of the first glass substrate toward the liquid crystal layer;
a color filter disposed on a side of the second glass substrate toward the liquid crystal layer;
a cover lens disposed on the second glass substrate; and
a touch control electrode structure disposed in the liquid crystal panel,
wherein a side of the first glass substrate away from the liquid crystal layer is coupled with a first polarizing film through a coating film, and a side of the second glass substrate away from the liquid crystal layer or a side of the second glass substrate toward the cover lens is coupled with a second polarizing film through the coating film.

9. The electronic apparatus of claim 8, wherein materials of the first polarizing film and the second polarizing film are polyvinyl alcohol (PVA).

10. The electronic apparatus of claim 9, wherein thicknesses of the first polarizing film and the second polarizing film are 5 μm to 10 μm, respectively.

11. The electronic apparatus of claim 9, wherein the thicknesses of the first polarizing film and the second polarizing film are 8 μm, respectively.

12. The electronic apparatus of claim 8, wherein the liquid crystal panel is an On-Cell Touch panel,
wherein when the second polarizing film is coupled to the second glass substrate, the touch control electrode structure is disposed between the second polarizing film and the cover lens; and when the second polarizing film is coupled to the cover lens, the touch control electrode structure is disposed between the second polarizing film and the second glass substrate.

13. The electronic apparatus of claim 8, wherein the liquid crystal panel is an In-Cell Touch panel, wherein the touch control electrode structure is disposed on the first glass substrate and between the liquid crystal layer and the thin film transistor array.

14. The electronic apparatus of claim 8, wherein the liquid crystal panel is an In-Cell Touch panel, wherein the touch control electrode structure is disposed on the second glass substrate and between the second glass substrate and the color filter.
